(19) United States
(12) Patent Application Publication
(10) Pub. No.: US 2001/0052882 A1
(43) Pub. Date: Dec. 20, 2001

(54) Helical antenna, method for manufacturing the helical antenna, and method for adjusting resonance frequency

(75) Inventors: Junichi Noro, Akita-shi (JP); Hirokazu Awa, Akita-shi (JP); Masaaki Miyata, Atsugi-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Mitsumi Electric Co. Ltd, Tokyo (JP)

(21) Appl. No.: 09/872,838

(22) Filed: Jun. 1, 2001

(30) Foreign Application Priority Data
Jun. 2, 2000 (JP) 165663/2000
Jun. 2, 2000 (JP) 166196/2000

(51) Int. Cl. H01Q 1/36

(52) U.S. Cl. 343/895; 343/713

(57) ABSTRACT

A plurality of copper wires are disposed between coaxially arranged an inner cylindrical member and an outer cylindrical member, with one end of each copper wire being fixed at a predetermined position. The remaining portion of each copper wire is spirally bent so as to wind itself around the inner cylindrical member, with the center axes of both the inner cylindrical member and the outer cylindrical member serving as a winding center. Then, an amount of insulative resin is poured into an annular space formed between the inner cylindrical member and the outer cylindrical member. In this way, the spirally deformed copper wires are sealed within the wall portion of a hollow cylindrical insulative resin member.

### BACKGROUND OF THE INVENTION

The present invention relates to an antenna for use with a digital radio receiver which can receive an electric wave transmitted from a satellite (hereinafter referred to as satellite wave) or an electric wave transmitted over the ground (hereinafter referred to as ground wave), and thus enables a user to listen to a digital radio broadcast.

Now, in the United States, a digital radio broadcast (using a frequency of about 2.3 GHz) involving the use of a satellite (a broadcast satellite) will soon be put into practical use. Meanwhile, research and development have already been in process in order to provide a digital radio receiver capable of receiving the digital radio broadcast.

Such a digital radio receiver is usually mounted on a mobile station such as an automobile vehicle. The digital radio receiver can receive an electric wave having a frequency of about 2.3 GHz, thereby enabling a user to listen to a digital radio broadcast. Namely, a digital radio receiver is a radio receiver which allows a user to listen to a mobile broadcast. On the other hand, a ground wave is formed by at first receiving a satellite wave in an earth station, followed by shifting the frequency of the received satellite wave.

Basically, there are two types of digital radio receivers. One is that which is cable of directly receiving an electric wave transmitted from a satellite, while the other is that capable of receiving an electric wave which has a shifted frequency and is transmitted from a ground station which has previously received an electric wave transmitted from a satellite. However, in the following, description will be given only to explain one type of digital radio receiver which is capable of directly receiving an electric wave transmitted from a satellite.

A digital radio receiver of the type cable of directly receiving an electric wave transmitted from a satellite is supposed to be mounted on an automobile vehicle. An antenna for use with such a digital radio receiver is usually a stick-like antenna if it is to be attached to the outside of an automobile vehicle.

In fact, a digital radio broadcast signal transmitted from a broadcast a satellite is a circularly polarized wave. As a stick-like antenna for receiving the circularly polarized wave, there has been well known a helical antenna. Such a helical antenna is simple in shape and compact in size. In addition, a helical antenna can be used as an antenna having a high gain.

In practice, a helical antenna is formed by helically (spirally) winding a plurality of conductive wires around a hollow cylindrical member or a solid cylindrical member (hereinafter simply referred to as cylindrical member). By making the diameter of the spiral to be equal to the wavelength of the circularly polarized wave, it is possible to transmit the circularly polarized wave in an axial direction of the cylindrical member. That is, the helical antenna constituted in the above-described manner can effectively receive the circularly polarized wave propagating along the axial direction.

Accordingly, the helical antenna has been used only for receiving a satellite signal. The cylindrical member may be formed by an electrically insulative material such as a plastic. Further, the number of the conductive wires may be for example four.

In order to increase the gain of the helical antenna, it is only required to increase the number of windings of the conductive wires coiled in a spiral manner. However, it is extremely difficult to spirally (helically) wind a plurality of conductive wires around a cylindrical member.

In view of the above, a helical antenna in a prior art is manufactured by at first printing several lengths of conductive patterns in an insulative sheet, and then winding the insulative sheet (on which the conductive patterns have been printed) around a cylindrical member.

Accordingly, for example, as shown in FIG. 1, it has been suggested that an insulative sheet 1 having formed thereon a plurality of conductive patterns 2 (an insulative sheet on which conductor strips have been printed) be wound around a cylindrical member 3, thereby forming a desired helical antenna.

The helical antenna formed in the above-described manner, has a resonance frequency whose value depends upon the height (length), diameter and inductivity of the cylindrical member.

The helical antenna is so formed that its output return loss will become the least at its resonance point. Such a resonance point will move (shift), depending upon a variation in size of the above cylindrical member. For this reason, in order to use the helical antenna to receive a satellite wave (circularly polarized wave) having a frequency of about 2.3 GHz, it is necessary to set the resonance point (the resonance frequency of the antenna) at a desired frequency (2.3 GHz).

On the other hand, during a process for manufacturing a number of helical antennas, it is impossible to avoid a size variation. Accordingly, it is necessary to use a certain kind of adjusting means (an adjusting method) to adjust the resonance frequency of each antenna.

Conventionally, in order to adjust the resonance frequency of each antenna, the front end portion of the helical antenna is cut off so as to adjust the length the antenna.

Namely, during the manufacture (manufacturing process), the length of each helical antenna is made relatively long in advance, in a manner such that it is possible for the antenna to receive a signal having a frequency lower than a desired frequency value. During adjustment (an adjusting step), the front end portion of each helical antenna is cut off so as to adjust the length of the antenna, thereby ensuring an effect that the resonance point will become a desired frequency. Such kind of an adjusting method is called a cutting method.

However, the adjustment of the satellite wave (circularly polarized wave) received by the helical antenna, is performed by using a phase shifter to shift the phases of various wave components to make the phases to be coincident with one another. By using the phase shifter to make the phases to be coincident with one another, a synthesizing process is thus effected. After that, the satellite wave is amplified by a low noise amplifier (LNA) and then fed to the receiver main body. Here, the combination of the helical antenna with the phase shifter as well as the low noise amplifier can be called an antenna apparatus.

As described in the above, the conventional helical antenna is manufactured by covering a cylindrical member with an insulative sheet on which a plurality of conductive patterns have been formed by means of printing.

However, the conventional manufacturing method includes the steps of preparing an insulative sheet, printing a plurality of conductive patterns, winding the insulative sheet around a separately prepared cylindrical member. At this time, the plurality of conductive patterns printed on the insulative sheet are in mutually separated positions. For this reason, when the cylindrical member is to be wound by the insulative sheet, it is necessary to wind the insulative sheet having formed thereon conductive patterns very carefully, in a manner such that each of the conductive patterns will be continuously extending around the surface of the insulative sheet covering the cylindrical member. As a result, the conventional manufacturing method fails to produce a helical antenna in a simplified process (such a simplified process has become necessary in the present social situation which requires that each commercial product be manufactured at a reduced cost so that it can be sold at a reduced price).

Moreover, the conventional helical antenna is adjusted in its resonance frequency by cutting the front end portion thereof. However, when using such a cutting method, in order to correctly make the resonance frequency to be coincident with a desired frequency, it is necessary that the front end portion of the helical antenna be cut only little by little. This, however, requires a considerable amount of time. The reason for this may be explained as follows. Namely, if the antenna is cut too short, it will be impossible for the resonance frequency of the helical antenna to return to a desired frequency, bringing about a result that the processed helical antenna can not be put into practical use.

In addition, since a considerable attention has to be paid in such a cutting operation, an extremely large amount of time is required. In view of this, there has been a demand that the resonance frequency of a helical antenna be adjusted easily, using one of other adjusting methods than the above-described conventional cutting method.

### SUMMARY OF THE INVENTION

It is a first object of the present invention to provide an improved helical antenna adapted to be easily manufactured at a low cost, also to provide a method for manufacturing the same.

It is a second object of the present invention to provide an improved helical antenna adapted to be manufactured at a low cost, by simplifying the structure of the antenna and simplifying the manufacturing process therefor, as well as making easy the fine adjustment of the resonance frequency. The present invention's second object is also to provide a method for manufacturing such a helical antenna, as well as a method for adjusting its resonance frequency.

A helical antenna according to the present invention has at least one spiral conductor, characterized in that the at least one spiral conductor is sealed within a cylindrical insulative body. In particular, the spiral conductor can be a copper wire.

Furthermore, a method for manufacturing a helical antenna according to the present invention, comprises the steps of deforming and thus disposing at least one metal wire in a space formed between an inner cylindrical member and an outer cylindrical member arranged in a coaxial relation with each other; and filling the space with an insulative resin.

Moreover, a helical antenna according to the present invention comprises a cylindrical member consisting of an insulative material such as a ceramic having a low inductivity; a helical antenna pattern formed by a plurality of conductive wires spirally arranged on the outer periphery surface of the cylindrical member; and a resist coat formed on the entire outer periphery surface of the cylindrical member, the entire outer periphery surface containing the helical antenna pattern.

Furthermore, a method for manufacturing a helical antenna according to the present invention, comprises the steps of using a pressure membrane printing process to form a helical antenna pattern including a plurality of conductive wires on the outer periphery surface of a cylindrical member consisting of a ceramic material having a low inductivity; and forming a resist coat to cover the cylindrical member containing the helical antenna pattern.

Namely, what is needed to be prepared as a member having a particular shape is only a cylindrical member, and an antenna pattern is then formed in a printing process on the outer periphery surface of the cylindrical member, followed by coating the same periphery surface so as to form a surface protection layer. Here, the formation of the antenna pattern as well as the surface coating treatment are all carried out in a conventional manner. However, since the formation of the antenna pattern and the surface coating treatment can all be directly conducted on the outer periphery surface of the cylindrical member, it is not necessary to perform an assembling operation.

Furthermore, a method for adjusting the resonance frequency of a helical antenna according to the present invention is characterized in that a predetermined resonance frequency is obtained by performing a laser trimming treatment to remove the front end portions of conductive wires constituting a helical antenna pattern formed in the helical antenna. With the use of the laser beam, it is possible to effect a fine trimming treatment on an antenna pattern. Therefore, it is easy to perform an adjustment of the resonance frequency in a simple operation as compared with a conventional cutting process.

### BRIEF DESCRIPTION OF THE DRAWINGS

FIG. 1 is a perspective view showing one example of a conventional process for manufacturing a helical antenna;

FIG. 2A is a transparent perspective view partially showing a helical antenna formed according to a first embodiment of the present invention;

FIG. 2B is an upper end view of the helical antenna shown in FIG. 2A;

FIG. 3 is a perspective view showing one step of a process for manufacturing the helical antenna of FIGS. 2A and 2B;

FIG. 4 is a perspective view showing a next step following the step of FIG. 3;

FIG. 5 is a perspective view showing a next step following the step of FIG. 4;

FIGS. 6A and 6B show a completed helical antenna obtained after the step of FIG. 5, FIG. 6A being a transparent view, FIG. 6B being a cross sectional view taken along line A-A in FIG. 6A; and

FIG. 7 is a perspective view showing a process for manufacturing a helical antenna according to a second embodiment of the present invention.

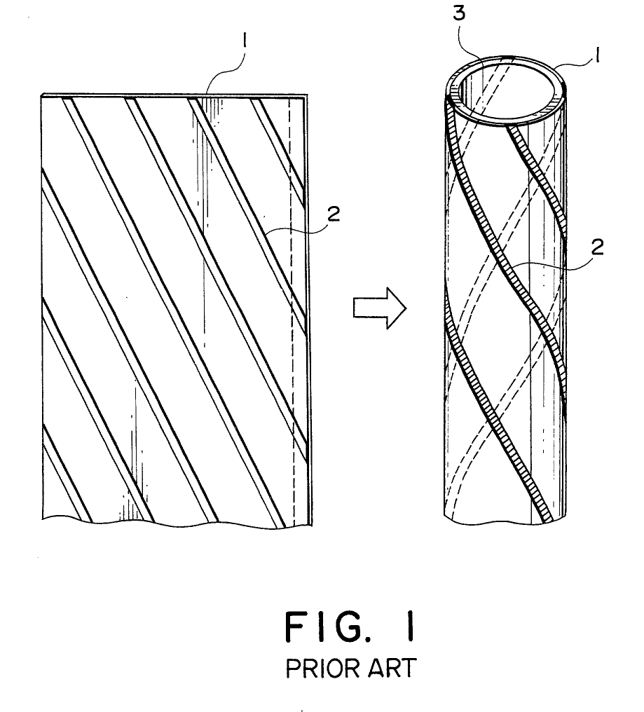

### DESCRIPTION OF THE PREFERRED EMBODIMENTS

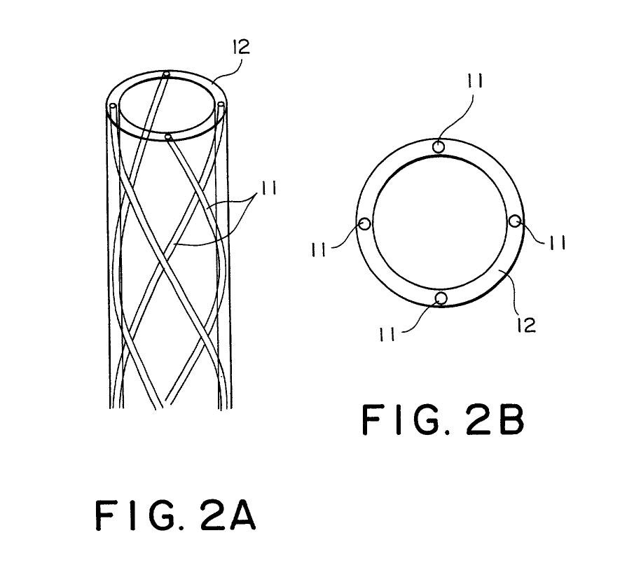

A first embodiment of the present invention will be described in the following with reference to the accompanying drawings. FIGS. 2A and 2B are used to illustrate a helical antenna (a four-phase feeding helical antenna) formed according to the first embodiment of the present invention. FIG. 2A is a partially transparent perspective view showing a frond end portion of the helical antenna and its adjacent area.

As shown in FIG. 2A, four lengths of spirally wound copper wires 11 are sealed within the wall portion of an insulative cylindrical member 12 made of a resin (i.e., sealed within the wall portion defined between the internal surface and the external surface of the cylindrical member). The four lengths of copper wires 11, as shown in FIG. 2B, are arranged at a predetermined equal interval in the circumferential direction of the cylindrical insulative resin member 12.

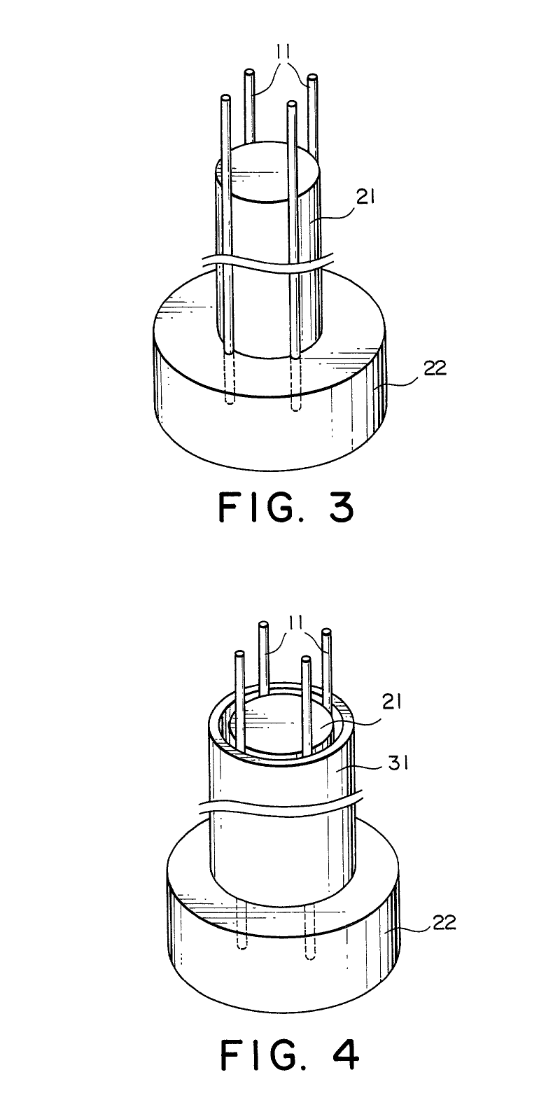

Next, a method for manufacturing the helical antenna shown in FIGS. 2A and 2B will be described with reference to FIGS. 3 to 6A, 6B. As shown in the drawings, at first, four copper wires 11 having substantially the same length are prepared. The four copper wires 11, as shown in FIG. 3, are then arranged along the outer periphery surface of an inner cylindrical member (metal mold) 21, in a manner such that the four copper wires 11 are equally distributed in four equally separated positions defined by equally dividing the outer circumference of the inner cylindrical member 21. Further, the four copper wires 11 are held and fixed in positions separated by a predetermined distance from the lower end face of the inner cylindrical member 21. In detail, a base section 22 is fixed on the lower end of the inner cylindrical member 21, and a plurality of elongate holes having a predetermined depth are formed within the base section 22, so that one end of each of the four copper wires 11 may be inserted in the elongated holes, thereby firmly holding and fixing the four copper wires 11. However, the height of the inner cylindrical member 21, under a condition shown in FIG. 3, should be lower than that of the copper wires 11 by a predetermined distance.

Then, as shown in FIG. 4, an outer cylindrical member (metal mold) 31 is disposed coaxially with the inner cylindrical member 21. In this way, the copper wires 11 (except both ends of each copper wire) are disposed within an annular space formed between the inner cylindrical member 21 and the outer cylindrical member 31. The height of the outer cylindrical member 31 is substantially the same as that of the inner cylindrical member 21.

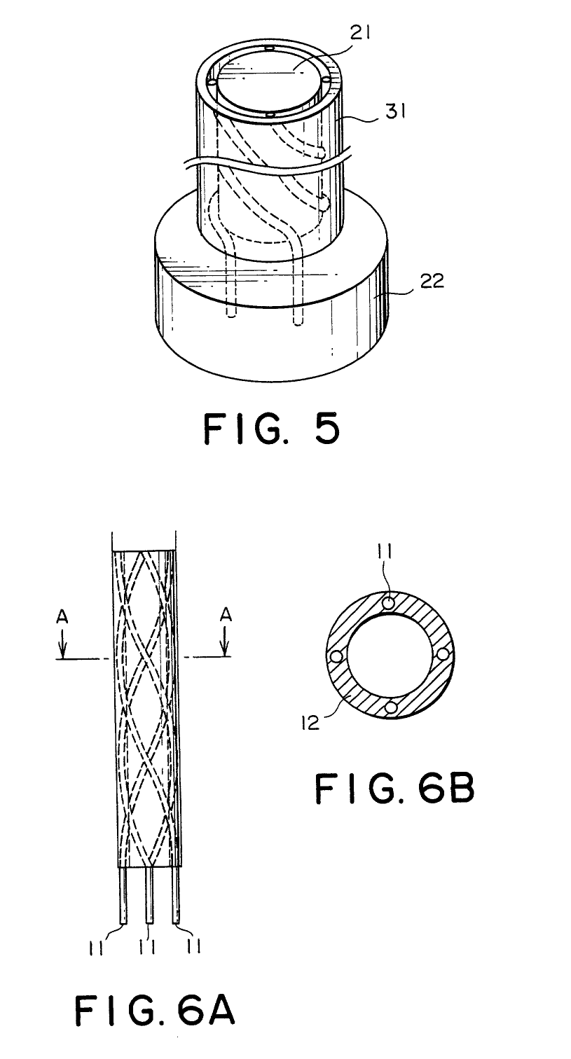

Next, a specifically formed jig not shown in the drawings is used to hold up the upper end of each copper wire 11. The jig is then rotated about the center axes of both the inner cylindrical member 21 and the outer cylindrical member 31. With the rotation of the jig, the jig itself is caused to get closer to both the inner cylindrical member 21 and the outer cylindrical member 31. As a result, the copper wires 11, as shown in FIG. 5, are deformed (spirally) so as to be wound around the inner cylindrical member 21, with the winding action being effected within the annular space formed between the inner cylindrical member 21 and the outer cylindrical member 31. However, at this time, the copper wires's portions inserted into the holes formed in the base section 22 are not deformed, and they can thus be used as output terminals after the completion of the manufacturing of the antenna.

Afterwards, the jig is used to block an opening formed (on the upper side in the drawings) between the inner cylindrical member 21 and the outer cylindrical member 31. At this time, the height of both the inner cylindrical member 21 and the outer cylindrical member 31 shall be set in a manner such that the copper wires 11 are formed into spiral configuration with a predetermined pitch.

Subsequently, an amount of insulative resin is poured into the annular space formed between the inner cylindrical member 21 and the outer cylindrical member 31. In practice, the insulative resin is poured into spaces (four sections) formed between the copper wires 11, in a manner such that each space section between the copper wires 11 may be exactly filled with the resin.

Finally, the jig, the outer cylindrical member 31 and the inner cylindrical member 21 are removed, thereby obtaining a helical antenna as shown in FIGS. 6A and 6B. Although it has been described in the present embodiment that copper wires may be used as conductive wires, it is also possible to use wires made of other metals.

In addition, although it has been described in the present embodiment that a helical antenna may contain four lengths of copper wires and thus forms a four-phase helical antenna, there should not be any limitation to the number of copper wires, provided that one or more than one wires are used in the antenna.

Furthermore, although a manufacturing method has been described in the present embodiment which involves the use of the inner cylindrical member fixed on the base section, the outer cylindrical member (different from the inner cylindrical member), as well as the specifically formed jig, the present invention should not be limited to such a specific embodiment. In fact, after the metal wires have been formed into spiral configuration, it is also possible to use other jig or device, provided that the jig or device in use is effective for sealing (insert formation) the deformed wires in the resin.

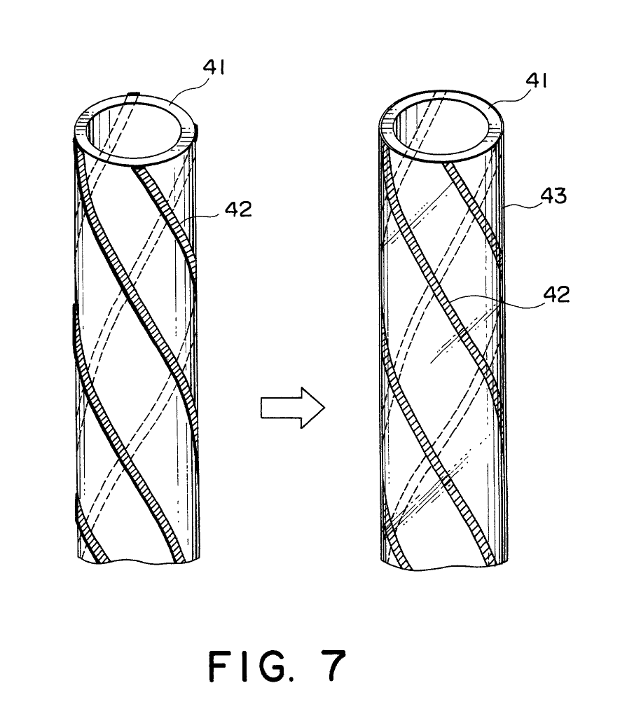

A second embodiment of the present invention will be described in the following with reference to accompanying drawing. FIG. 7 is a perspective view showing a helical antenna formed according to the second embodiment of the present invention.

The helical antenna shown in FIG. 7 has a cylindrical bobbin 41 made of a ceramic material having a low inductivity, so that the bobbin 41 serves as a cylindrical member. A plurality of conductive wires mainly containing a silver are wound around the outer periphery surface of the cylindrical bobbin, thereby forming a helical antenna pattern 42. Further, the outer periphery surface of the bobbin 41 serving as a cylindrical member containing the antenna pattern, is coated with an overcoat formed by a resist glass which is green in color, thereby forming a resist coat 43.

In the following, the process for manufacturing the helical antenna will be described with reference to FIG. 7. In a first step, several lengths of silver paste are printed on the outer periphery surface of the cylindrical bobbin 41 formed by a ceramic material having a low inductivity, the printing process being carried out using a pattern mask for forming the antenna pattern 42, followed by a baking process conducted at a temperature which may be for example 900° C., thereby completing the whole process which can be called pressure membrane method. In fact, the paste strips may be printed by rotating the cylindrical bobbin 41 on a plain surface containing a pattern mask formed thereon.

Next, description will be given to explain the method for forming the antenna pattern 42 on the outer periphery surface of the cylindrical bobbin 41.

Briefly speaking, this is a method which uses a silver paste to form an antenna pattern corresponding to the positions of a plurality of conductive wires on the cylindrical bobbin 41. Namely, by rotating the bobbin 41 on a plain surface containing an antenna pattern, an antenna pattern may be formed on the outer periphery surface of the bobbin 41, thereby completing a printing process for printing the antenna pattern by the silver paste. Afterwards, the baking process is conducted at a temperature of 900° C., so that the first step is completed.

Then, in a second step, the outer periphery surface of the bobbin 41 (on which an antenna pattern 42 has been formed in the above first step) is completely coated with a green resist glass, followed by a baking treatment at a temperature of 500° C., thereby forming an overcoat 43 serving as a resist coat and thus completing the coating treatment. In this way, the manufacturing of antenna product can be finished in an assembling process which is more simplified than a conventional assembling process.

Although it has been described in the present disclosure that the bobbin may be formed by a ceramic substrate having a low inductivity, such a bobbin can also be formed by other materials, provided that they are insulative materials which can serve as a pressure membrane print substrate. Further, although it has been described in the present disclosure that the bobbin is cylindrical in shape, it is also possible that such a bobbin may be polygonal in its cross section. Moreover, although it has been described in the present disclosure that silver may be used to form a conductor in an antenna pattern, it is also possible for the antenna pattern to be formed by at least one of other metals including gold, palladium, copper and the like. In addition, the resist coat should not be limited to the green resist glass. In fact, it is also possible for the resist coat to be formed by other materials, provided that they are insulative materials which can be used to form the resist coat.

The front end portions of the formed conductive wires constituting the antenna pattern 42 are cut off by means of trimming treatment using a laser light beam, which trimming treatment being continued until a desired resonance frequency is obtained. In this way, since the laser light beam is extremely small in its cross section, it is possible to perform a fine adjustment in the length of the conductive wires during the trimming treatment. In other words, it is easy to obtain a desired resonance frequency. However, during the trimming treatment, it is of course that both the antenna pattern 42 and the overcoat layer 43 covering the antenna pattern are all partially cut off at their upper portions.

According to the present invention, since the helical antenna is so constructed that the spiral conductor is sealed within a cylindrical insulative body, the manufacturing of the antenna can be made easy and at a low cost.

Furthermore, according to the present invention, since the at least one metal wire is deformed and thus disposed in a space formed between an inner cylindrical member and an outer cylindrical member arranged in a coaxial relation with each other, and since an amount of insulative resin is poured and thus fills the space formed between the inner cylindrical member and the outer cylindrical member, it is possible to manufacture the helical antenna in a simplified process and at a low cost.

Moreover, according to the present invention, a pressure membrane printing process is carried out to form a helical antenna pattern including a plurality of helical conductive wires on the outer periphery surface of a cylindrical bobbin consisting of a ceramic substrate having a low inductivity, and an insulative overcoat is formed to cover the entire periphery surface of the cylindrical bobbin containing the helical antenna pattern.

In this way, it is possible to manufacture the antenna using a fewer number of parts and a simplified process, as compared with conventional antenna products.

Furthermore, using the method of the present invention for adjusting the resonance frequency of a helical antenna, a predetermined resonance frequency may be obtained by performing a laser trimming treatment to remove the front end portions of conductive wires constituting a helical antenna pattern formed in the helical antenna. With the use of the laser beam, it is possible to effect a fine trimming treatment on an antenna pattern. Therefore, it is easy to perform an adjustment of the resonance frequency in a simple operation as compared with a conventional cutting process.

With the use of the above-described constitution and the manufacturing method as well as the adjusting method, it is possible to obtain an effect of reducing the price of each helical antenna product as compared with a corresponding conventional helical antenna.

What is claimed is:

1. A helical antenna having at least one spiral conductor, wherein the at least one spiral conductor is sealed within a cylindrical insulative body.

2. A helical antenna as claimed in claim 1, wherein the spiral conductor is a copper wire.

3. A method for manufacturing a helical antenna having at least one spiral conductor, said method comprising the steps of:
deforming and disposing spirally at least one metal wire in a space formed between an inner cylindrical member and an outer cylindrical member arranged in a coaxial relation with each other; and
filling the space with an insulative resin.

4. A helical antenna comprising:
a cylindrical member consisting of an insulative material;
a helical antenna pattern formed by a plurality of conductive wires spirally arranged on the outer periphery surface of the cylindrical member; and
a resist coat formed on the entire outer periphery surface of the cylindrical member, the entire outer periphery surface containing the helical antenna pattern.

5. A helical antenna as claimed in claim 4, wherein the insulative material is a ceramic having a low inductivity.

6. A method for manufacturing a helical antenna, comprising the steps of:
forming a helical antenna pattern consisting of a plurality of conductive wires on the outer periphery surface of a cylindrical member consisting of an insulative material by using a pressure membrane printing process to; and
forming a resist coat to cover the cylindrical member containing the helical antenna pattern.

7. A method for manufacturing a helical antenna as claimed in claim 6, wherein the pressure membrane printing process on the outer periphery surface of the cylindrical member comprises:
forming an antenna pattern corresponding to the positions of several conductive wires by using a silver paste on a plain surface;
rotating the cylindrical member on the plain antenna pattern;
printing the antenna pattern on the outer periphery surface of the cylindrical member by using the silver paste passing through a pattern mask
sintering the printed antenna pattern.

8. A method for adjusting the resonance frequency of a helical antenna which comprises a cylindrical member consisting of an insulative material, a helical antenna pattern formed by a plurality of conductive wires spirally arranged on the outer periphery surface of the cylindrical member, and a resist coat formed on the entire outer periphery surface of the cylindrical member, the entire outer periphery surface containing the helical antenna pattern, wherein:
a predetermined resonance frequency is obtained by performing a laser trimming treatment to remove the front end portions of the conductive wires.
